(19) United States
(12) Patent Application Publication
(10) Pub. No.: US 2011/0236138 A1
(43) Pub. Date: Sep. 29, 2011

(54) METHOD FOR REPAIRING AND REINFORCING UNDERGROUND PIPES

(76) Inventor: William C. COSBAN, Schaumburg, IL (US)

(21) Appl. No.: 12/730,645

(22) Filed: Mar. 24, 2010

(51) Int. Cl. F16L 55/162

(52) U.S. Cl. 405/184.2

(57) ABSTRACT

A method of repairing or reinforcing underground pipes includes the steps of providing a flexible liner assembly having a first end and a second end, applying an internal pressure to the flexible liner assembly, inserting the first end of the liner assembly into a first end of a pipe section while maintaining the internal pressure, pushing the flexible liner assembly through the pipe section while maintaining the internal pressure, releasing the internal pressure from the flexible liner assembly, and connecting the first and second ends of the flexible liner assembly to the pipe section so that the flexible liner assembly provides a substantially leak-free conduit through the pipe section. The method addresses drawbacks associated with prior art methods by preventing or reducing contact between the flexible liner assembly and sharp inner corners of the pipe section, thereby reducing drag between the flexible liner assembly and the interior of the pipe section.

### FIELD OF THE INVENTION

This invention is directed to a method for repairing and reinforcing underground pipes, which does not require excavation to reach the section of pipe requiring repair and/or reinforcement.

### BACKGROUND OF THE INVENTION

Underground pipes used for swimming pools, wells, sewers, other water systems and electrical cables can become cracked after many years of use. Such cracking can result from shifting of the earth, growth of roots, and placement of heavy objects on the ground above the pipes. If the pipe is a water supply or drain pipe, the cracking can cause water to leak from the pipe. If the pipe is used to house electrical cable, the cracking can cause water to leak into the pipe. In either case, the cracking can result in failure of the pipe for its intended purpose.

Repair of the damaged pipe can be accomplished by excavating the surrounding ground and repairing and replacing the damaged pipe or damaged sections of it. This process can be expensive and time consuming. An improved system and method for repairing and reinforcing underground pipes are disclosed in U.S. Pat. Nos. 7,137,757 and 7,241,076, both issued to Cosban, which are incorporated by reference. The disclosed system and method involve pulling a liner assembly through a length of the pipe and anchoring and sealing the liner assembly at both ends. The liner assembly includes a smooth flexible bore liner and a semi-rigid reinforcing helix that prevents or inhibits collapse of the liner within the pipe. Once the liner assembly has been pulled through the pipe and sealed at both ends, it functions as a new inner pipe wall which isolates the interior of the pipe from the cracks in the original pipe wall.

One drawback of the foregoing system and method is illustrated in FIG. 1. In FIG. 1, a liner assembly 10 including a smooth flexible bore liner 12 and a semi-rigid reinforcing helix 14 is being pulled through a pipe section 16 using a nylon cord 18 connected to a temporary liner head 20. The pipe section 16 has a wall 22 that bends and defines a sharp inner corner 24. As the liner assembly 10 is pulled through the pipe section 16, the liner assembly 10 is urged against the sharp inner corner 24 of wall 22. The semi-rigid helix 14 can become ensnared by the sharp inner corner 24, causing the smooth flexible bore liner 12 to become punctured, torn or otherwise damaged, and sometimes causing at least a partial collapse of the liner assembly 10. Even if the liner assembly 10 is not damaged, the sharp corner 24 can make it difficult or awkward to pull the liner assembly 10 through the pipe section 16. The amount of drag or resistance when pulling the liner assembly 10 can become intolerable when there are multiple corners in the pipe being repaired and/or when the pipe and liner assembly are long.

There is a need or desire for an improved system and method for repairing and reinforcing underground pipes which overcomes the foregoing difficulty.

### SUMMARY OF THE INVENTION

The present invention is directed to an improved system and method for repairing and/or reinforcing underground pipes which minimizes and substantially reduces the resistance and drag encountered when moving the liner assembly through the pipe. The method includes the steps of providing a flexible liner assembly having a first end and a second end, applying an internal pressure to the liner assembly, inserting the first end of the liner assembly into a first end of a pipe section while maintaining the internal pressure, pushing the liner assembly through the pipe section while maintaining the internal pressure until the first end of the liner assembly reaches a second end of the pipe section, and releasing the internal pressure from the liner assembly. The method may include the steps of sealing the first and second ends of the liner assembly before pushing the liner assembly through the pipe section, to facilitate pressurization and maintain the internal pressure, and unsealing the first and second ends of the liner assembly to facilitate the release of internal pressure. The method may also include the step of connecting first and second ends of the installed liner assembly to the pipe section so that the liner assembly provides a substantially leak-free conduit through the pipe section.

The flexible liner assembly can include a smooth flexible bore liner and a semi-rigid reinforcing helix, and can be closed at both ends to maintain internal pressure. The flexible liner assembly can alternatively include another flexible material, such as a corrugated plastic material, which can be closed at both ends. The closure device can include a screw-in pressure plug at one or both ends which connects to an air compressor and transmits pressurized air to the interior of the liner assembly. Other types of closure devices can also be used.

The air pressure in the liner assembly should be high enough so that the liner assembly can be pushed through the interior or the pipe section without collapsing, and low enough that the liner assembly has sufficient flexibility to bend around the corners in the pipe section.

By providing a liner assembly that can be pushed through a pipe section, instead of being pulled, contact between the liner assembly and sharp corners of the pipe section can be generally avoided. The liner assembly does not become ensnared at the sharp corners, and less resistance is encountered when moving the liner assembly through the pipe section. This facilitates the repair of longer pipe sections, and pipe sections having a greater number of turns, than can be accomplished by pulling the liner assemblies through the pipe sections.

With the foregoing in mind, it is a feature and advantage of the invention to provide an improved method for repairing and reinforcing underground pipes which avoids or minimizes the problems associated with flexible liner assemblies becoming ensnared at the sharp corners of pipe sections.

It is also a feature and advantage of the invention to provide an improved liner assembly which can maintain internal pressure, enabling the liner assembly to be pushed instead of pulled through the pipe section.

The foregoing and other features and advantages of the invention will become further apparent from the following detailed description of the invention, read in conjunction with the accompanying drawings. The detailed description and drawings are intended to be illustrative rather than limiting, the scope of the invention being defined by the appended claims.

### BRIEF DESCRIPTION OF THE DRAWINGS

FIG. 1 schematically illustrates a prior art method of repairing or reinforcing an underground pipe that includes the step of pulling a liner assembly through a pipe section.

FIG. 2 schematically illustrates an inventive method of repairing or reinforcing an underground pipe that includes the step of pushing an internally pressurized liner assembly through a pipe section.

FIG. 3 schematically illustrates the use of a pig and a tag line to measure the length of a pipe section and determine the design length of a liner assembly to be inserted.

FIG. 4 is a perspective view of a screw-in end plug that can be attached to both ends of the liner assembly to maintain internal pressure during installation of the liner assembly into the pipe section.

FIG. 5 is a perspective new of the liner assembly of FIG. 4 with a gas injection nozzle attached, to inject pressurized gas such as air into the liner assembly.

FIG. 6 is a perspective view of an end cap for the liner assembly of FIG. 4.

FIG. 7 is a top view of the liner assembly of FIG. 4, further equipped with two small partial openings for receiving a special two-pronged tool.

FIG. 8 is a perspective view of one embodiment of a retainer sleeve that can serve as an adapter between one or both ends of the installed liner assembly and corresponding one or both ends of the pipe section.

FIG. 9 is a perspective view of an end of a pipe section with the retainer sleeve of FIG. 8 attached, and equipped with a threaded connector sleeve for connecting the pipe section to a main pipe or pipe assembly.

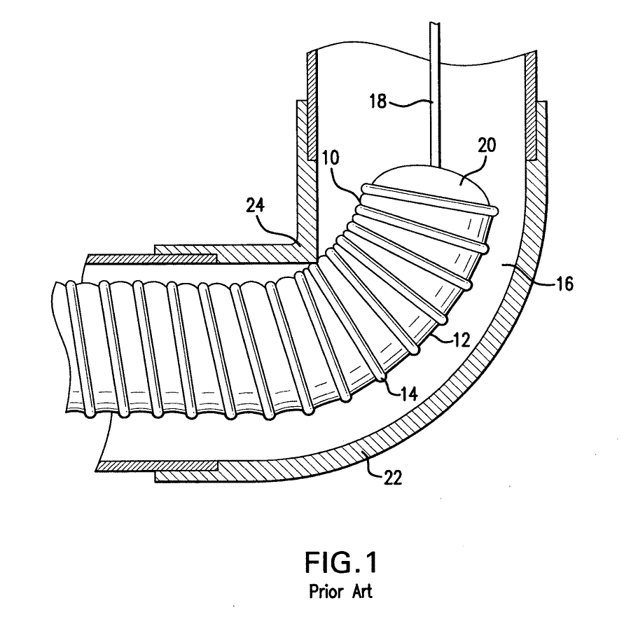

### DETAILED DESCRIPTION OF THE INVENTION

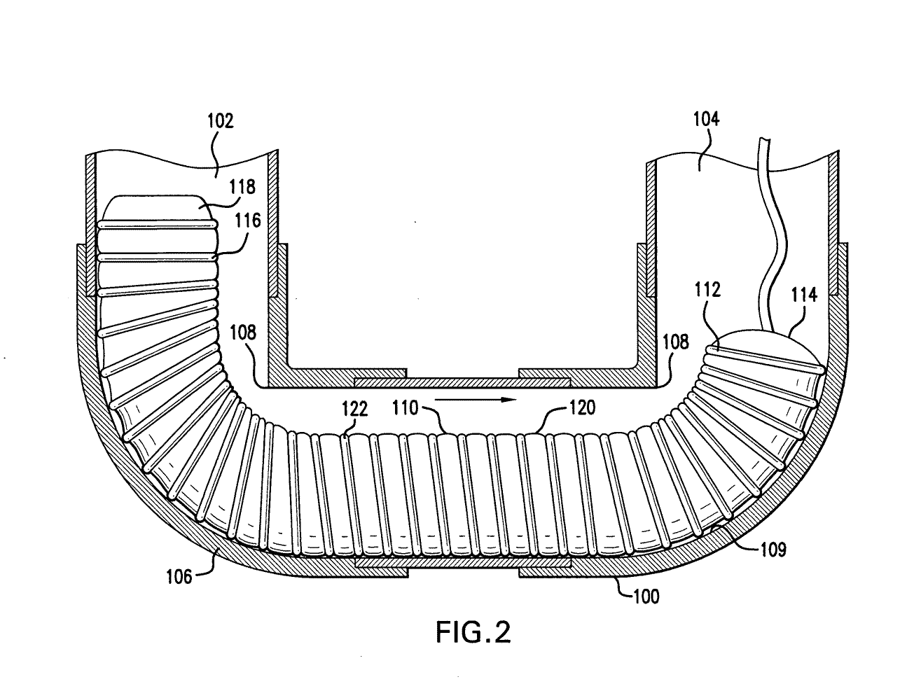

Referring to FIG. 2, a pipe section 100 is shown having a first end 102, a second end 104, and a wall 106 having two sharp inner corners 108. A flexible liner assembly 110 is provided including a first end 112 covered by plug 114, and a second end 116 covered by plug 118. The illustrated flexible liner assembly 110 includes a smooth flexible liner bore 120 and a semi-rigid reinforcing helix 122. In alternative embodiments, the flexible liner assembly 110 may be formed of a corrugated semi-rigid plastic material, or another suitable material.

In order to repair or reinforce the pipe section 100 using the flexible liner assembly 110, a selected pressure, such as air pressure, is applied internally in the liner assembly 110. The internal pressure is large enough to maintain integrity and prevent collapse of the liner assembly 110, but not so large as to prevent bending and flexing of the liner assembly 110. The plugs 114 and 118 or other suitable means are employed to maintain the desired pressure inside the liner assembly 110. The desired pressure inside the liner assembly 110 is generally about two (2) to about twenty (20) psi, suitably about three (3) to about six (6) psi. The optimum pressure may be different for different applications, depending on the length and diameter of the pipe section 100, the length and diameter of the liner assembly 110, the material of construction of the liner assembly 110, the number of turns in the pipe section 100, and other factors.

While maintaining the internal pressure, the first end 116 of the liner assembly 110 is inserted into the first end 102 of the pipe section 100. The liner assembly 110 is then pushed through the pipe section 100 in the direction of the arrow until the first end 116 of liner assembly 110 approaches or reaches the second end 104 of pipe section 100. As shown in FIG. 2, because the pressurized liner assembly 110 is being pushed instead of pulled, the liner assembly 110 urges away from the sharp inner corners 108 of the wall 106 of pipe section 100, and instead slides along the smoothly curved outer portions 109 of the wall 106. There is little or no risk of liner assembly 110 becoming ensnared by the sharp inner corners 108, and the liner assembly 110 passes through the pipe section 100 with minimal resistance.

The liner assembly 110 suitably has a predetermined length that is approximately equal to the length of the pipe section 100 being repaired or reinforced. This way, when the first end 112 of the liner assembly 110 approaches the second end 104 of the pipe section 100, the second end 116 of the liner assembly 110 will approach the first end 102 of the pipe section 100. Because the liner assembly 110 is flexible, it may have a length that is slightly longer or slightly shorter than the length of pipe section 100. Suitably, the length of the liner assembly 110, while internally pressurized, is within about 20%, or within about 10% of the length of pipe section 100.

After the liner assembly 110 is fully inserted in the pipe section 100, such that the first end 112 of the liner assembly 110 reaches the second end 104 of pipe section 100, the internal pressure is released from the liner assembly 110. This can be accomplished by removing the end plugs 114 and 118 from the liner assembly 110. Before or after the internal pressure is released, the outer circumference of the first end 112 of the liner assembly 110 can be sealed to the inner circumference of the second end 104 of pipe section 100, and the outer circumference of the second end 114 of the liner assembly 110 can be sealed to the inner circumference of the first end 102 of the liner assembly 110. By virtue of the sealing, and the removal of end plugs 114 and 118, the interior of the liner assembly 110 then functions as the interior of the pipe section 100 for purposes of passing fluids or storing electrical cable. The flexible liner assembly 110 provides a leak-free conduit, while the original pipe section 100 provides structural integrity.

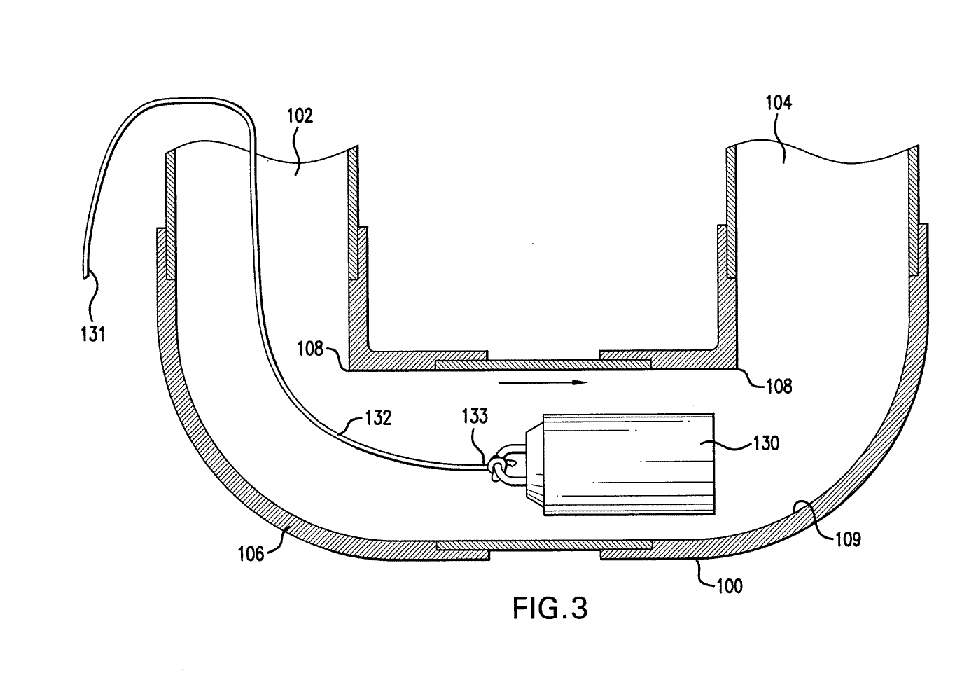

The desired length of the liner assembly 100 can be determined by initially measuring the length of the pipe section 110 using a pig 130 attached to a tag line 132 as shown in FIG. 3. Pig 130 can be made of polystyrene foam or another lightweight material, and has a cylindrical shape or other suitable shape that allows it to be transported through pipe section 100 using a blast of air from the first end 102 and/or vacuum from the second end 104. The tag line 132 has a length at least as high as the length of pipe section 100 and can range from about 50 feet to several hundred feet. The pig 130 can be transported through the pipe section 100 in the direction of the arrow using a blow gun applied at the first end 102 and/or a wet/dry vacuum applied at the second end 104. When the pig 130 reaches the second end 104, the tag line 132 can be detached or left attached. The length of the tag line between the first end 102 and the second end 104 is then measured to determine the design length of the liner assembly 110.

The pig 130 can alternatively be in the form of a wooden sphere, a plastic bag containing foam pieces, or another suitable material. When the pig 130 is formed as a wooden sphere, a fluid such as water can alternatively be employed to transport the pig 130 through the pipe section 100. The length of pipe section 100 is typically the underground length, measured from a convenient entry point upstream from where the pipe section 100 enters the ground to a convenient exit point downstream from where the pipe section 100 leaves the ground.

When the liner assembly 110 is formed of a smooth flexible bore 120 and semi-rigid helix 122, the smooth flexible bore 120 can be formed of polyamide, polypropylene, polyethylene, EPDM, nitrile, PVC/NBR (polyvinyl chloride/nitrile butadiene rubber) blends, or another suitable flexible material having good long-term stability during use. The semi-rigid helix 122 can be formed of polypropylene, polyethylene, wire reinforcement, or another suitable semi-rigid material. The semi-rigid helix 122 can be inside the flexible bore 120, or may be external to the flexible bore 120, in which case the flexible bore 120 is adhered to the semi-rigid helix 122 using heat or a suitable adhesive material. A commercially available material that combines the flexible bore 120 and semi-rigid helix 122 is sold by Kuryama of America, located in Schaumburg, Ill., under the trade name TIGERFLEX®.

The liner assembly 110 may alternatively be formed using a semi-rigid corrugated plastic material. Suitable plastic materials include without limitation polypropylene, high density polyethylene, polyamides, polyvinyl chloride, PVC/NBR blends, and laminates thereof. Other suitable materials and structures may also function as the liner assembly 110, provided that the liner assembly 110 has sufficient flexibility to pass around corners in the pipe section 100, and sufficient rigidity to avoid collapse.

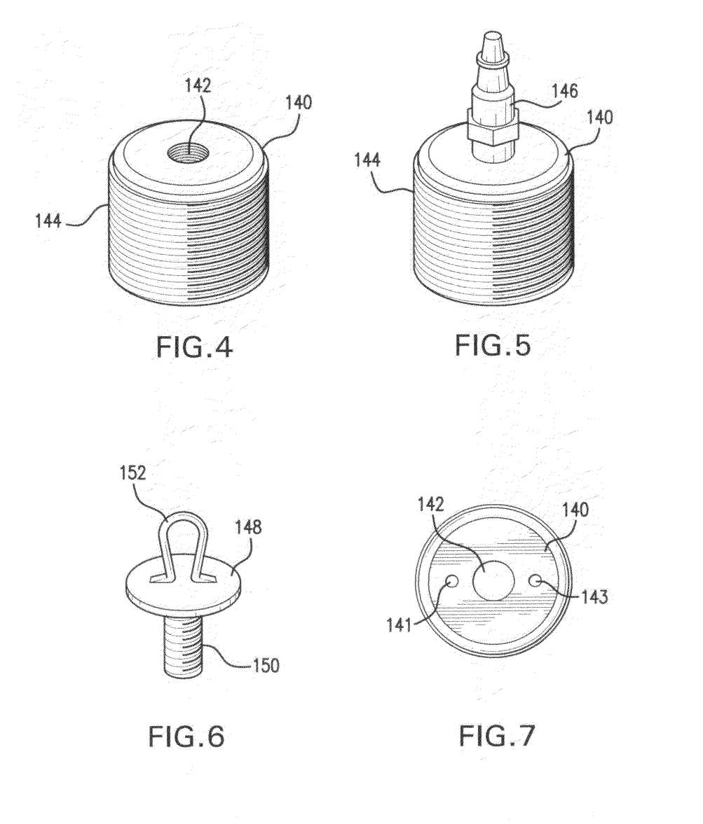

The plugs 114 and 118 can be externally threaded plugs that screw into mating threads provided at the respective ends 112 and 116 of the liner assembly 110 to provide a substantially air-tight seal. FIG. 4 illustrates one embodiment of plug 114 or 118, designated as a threaded plug 140 having an internally threaded opening 142 and external threads 144. FIG. 5 illustrates the same plug 140 in which an injection nozzle 146 is connected to inlet 142 to permit the controlled injection of air from a pressurized air supply (not shown). FIG. 6 illustrates the same plug 140 in which a top cap 148 having a threaded portion 150 is screwed, pressure fitted, or otherwise sealed in the opening 142. The top cap 148 optionally has a hook or loop 152 which can be connected to a tag line, as further explained below.

When the liner assembly 110 is being pressurized, prior to insertion into the pipe section 100, a first plug 114 (represented by a combination of threaded plug 140 and end cap 148) can be screwed into the first end 112 of the liner assembly 110 with the aid of an epoxy or other sealant, if necessary, to provide a sealed fit. A second plug 118 (represented by a combination of threaded plug 140 and injection nozzle 146) can be screwed into the second end 116 of the liner assembly 110 with the aid of an epoxy or other sealant, if necessary. Air from a pressurized air supply (not shown) can be injected through nozzle 146 into the liner assembly 110 until a desired pressure is achieved. Then, the air supply is isolated and the injection nozzle 146 is removed from the second plug 118 and replaced with an end cap 148.

At this point, the pressure inside the liner assembly 110 is maintained, and the liner assembly 110 can be inserted into the pipe section 100 by pushing from the second end 116 as described above. Alternatively, the liner assembly 110 can be inserted into the pipe section 100 using a combination of pushing from the second end 116 and pulling from the first end 112. In order to perform the combination of pushing and pulling, the trailing end 131 of the tag line 132 shown in FIG. 3 can be tied or otherwise connected to the hook 152 of the end cap 148 on the first end plug 114 on the liner assembly 110. This is accomplished before the liner assembly 110 is inserted into the pipe section 100. Then, the liner assembly 110 can be inserted by pushing from the second end 116, as explained above, and pulling from the first end 112 by pulling the leading edge 133 of the tag line 132 which can be connected to the pig 130. Depending on the application, the pushing and pulling of the liner assembly 110 through pipe section 100 need not be performed simultaneously. In some applications, it may be desirable to perform an alternating sequence of pushing and pulling. In other applications, it may be desirable to continuously push from the second end 116 of the liner assembly and only occasionally pull from the first end 112 of the liner assembly. By designing the liner assembly 110 for both pushing and pulling, the user has the flexibility to perform whatever steps are necessary to successfully insert the liner assembly 110 into the pipe section 100.

The plugs 114 and 118 can be formed of any suitable material such as polyvinylchloride, polypropylene, high density polyethylene or the like. The end plugs 114 and 118 are not limited to the foregoing configurations. Also, the tag line 132 should be formed of a material that is sufficiently strong to accommodate the liner assembly 110, but does not cut and groove any portion of the wall 106 of the pipe section 100. If the material of the tag line 132 is too sharp, it may cut and groove the sharp inner corners 108, causing unwanted drag. One particularly suitable material for the tag line 132 is a flat nylon tape having a width of at least about 0.5 inch.

As illustrated in FIG. 7, the top of the plug 140 may be designed with two small partial openings 141 and 143 that do not extend all the way through the plug 140. The partial openings 141 and 143 are intended to accommodate a special two-pronged tool which facilitates the screwing and unscrewing of the plug 140 from the liner assembly 110.

After the liner assembly 110 has been fully inserted into the pipe section 100, the internal pressure is released by removing both end plugs 114 and 118. If the threaded plugs 140 are used, they can be unscrewed with the aid of a two-prong tool that engages openings 141 and 143. After the end plugs 114 and 118 are removed (or, in some instances, before), the outer surface of the end portions 112 and 116 of the liner assembly 110 can be fitted to the inner surface 109 of the pipe section 110. Typically, the first end 112 of liner assembly 110 is fitted to the pipe section 100 near its second end 104, and the second end 116 of liner assembly 110 is fitted to the pipe section 100 near its first end 102.

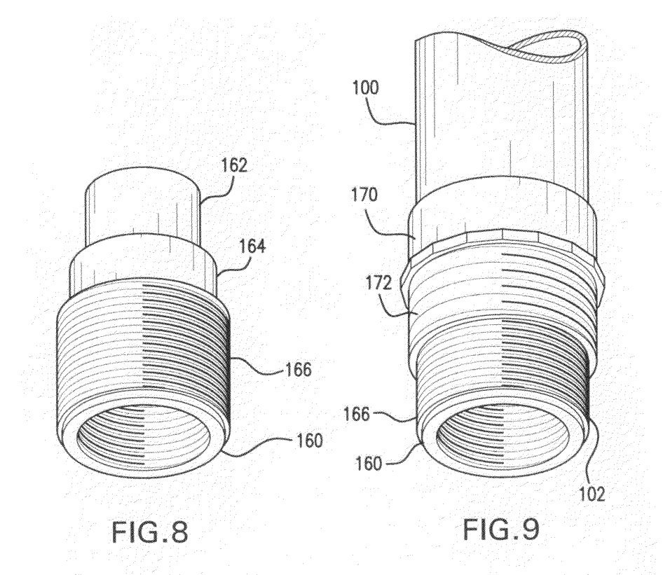

In order for the installed liner assembly 110 to serve as a conduit within the pipe section 100, it is important to provide leak-proof seals between the ends of the liner assembly 110 and the pipe section 100. In most instances, the outer diameter of liner assembly 100 is slightly smaller than the inner diameter of pipe section 100. In order to accommodate the differences in diameter, a retainer sleeve 160, such as shown in FIG. 8, can be provided at both ends 102 and 104 of pipe section 100 to serve as an adapter between liner assembly 110 and pipe section 100.

The retainer sleeve 160 has a first portion 162 of narrower outer diameter, a second portion 164 of intermediate outer diameter, and a third portion 166 of wider outer diameter. The first portion 162 may or may not be threaded, and is adapted to engage the inner surface of liner assembly 110 at either or both ends 112 and 116. The outer diameter of first portion 162 is about equal to the inner diameter of liner assembly 110. An epoxy or other sealant can be applied to form an air and water tight, pressure resistant seal.

The second portion 164 may or may not be threaded, and is adapted to engage the inner surface of pipe section 100 at either or both ends 102 and 104. The outer diameter of second portion 164 is about equal to the inner diameter of pipe section 100 at either or both ends. An epoxy or other sealant can be applied to form an air and water tight, pressure resistant seal.

The third portion 166 may or may not be threaded, and has an outer diameter about equal to the outer diameter of pipe section 100 at either or both ends. As shown in FIG. 9, when the retainer sleeve 160 is fully installed, the third portion 166 may appear as a short extension of pipe section 100 at one or both ends 102 and 104. The pipe section 100 can then be reconnected to the main pipeline or pipe assembly from which it was disconnected to initiate the repair or reinforcement. If the ends of the pipe section 100 are equipped with a standard threaded connector sleeve 170 having threads 172, the connector sleeve 170 can be reconnected to a mating connector sleeve on the main pipeline or pipe assembly (not shown). The reconnection of mating connector sleeves further reinforces the position of retainer sleeve 160 at one or both ends of pipe section 100. Sealing rings, such as O-rings, can also be used to reinforce the connection between connector sleeves 170 and mating connector sleeves.

The embodiments of the invention described herein are exemplary. Various modifications and improvements can be made without departing from the sprit and scope of the invention. The scope of the invention is indicated by the appended claims, and all changes that fall within the meaning and range of equivalents are intended to be embraced therein.

I claim:

1. A method for repairing or reinforcing a pipe section, comprising the steps of:
providing a flexible liner assembly having a first end and a second end;
applying an internal pressure to the flexible liner assembly;
inserting at least a portion of the flexible liner assembly into the pipe section while maintaining the internal pressure;
pushing the flexible liner assembly through the pipe section while maintaining the internal pressure;
releasing the internal pressure from the flexible liner assembly; and
connecting the first and second ends of the flexible liner assembly to the pipe section so that the flexible liner assembly provides a substantially leak-free conduit through the pipe section.

2. The method of claim 1, further comprising the steps of sealing the first and second ends of the liner assembly to maintain the internal pressure, and unsealing the first and second ends of the liner assembly to release the internal pressure.

3. The method of claim 2, wherein the sealing step includes the step of attaching an end plug to each of the first and second ends of the flexible liner assembly and the unsealing step includes the step of removing the end plugs.

4. The method of claim 3, wherein at least one of the end plugs is adapted to receive an injection nozzle, and the step of applying an internal pressure to the liner assembly includes the step of injecting a pressurized gas through the injection nozzle.

5. The method of claim 1, wherein the step of connecting first and second ends of the liner assembly to the pipe section includes the step of connecting a retainer sleeve to at least one end of the liner assembly and a corresponding end of the pipe section to provide a substantially leak-free seal between the liner assembly and the pipe section.

6. The method of claim 5 wherein a retainer sleeve is connected to each end of the liner assembly and each corresponding end of the pipe section.

7. The method of claim 5, wherein the retainer sleeve includes a first portion having a narrower outer diameter about equal to an inner diameter of the liner assembly, a second portion having an intermediate outer diameter about equal to an inner diameter of the pipe section, and a third portion having a wider outer diameter about equal to an outer diameter of the pipe section.

8. The method of claim 1, further comprising the steps of measuring a length of the pipe section and providing the liner assembly with a length that is within about 10% of the length of the pipe section.

9. The method of claim 8, wherein the length of the pipe section is measured by transporting a pig through the pipe section from a first end to a second end of the pipe section, the pig being attached to a leading end of a tag line, and measuring a length of the tag line that is pulled into the pipe section by the pig.

10. The method of claim 9, further comprising the steps of attaching a trailing end of the tag line to the first end of the liner assembly, and pulling the liner assembly at least part of a distance through the pipe section using the tag line.

11. A method for repairing or reinforcing a pipe section, comprising the steps of:
providing a liner assembly having a first end and a second end;
applying an internal pressure to the liner assembly;
inserting at least a portion of the liner assembly into the pipe section while maintaining the internal pressure;
pushing the flexible liner assembly at least part of a distance through the pipe section while maintaining the internal pressure;
pulling the flexible liner assembly at least part of the distance through the pipe section;
releasing the internal pressure from the flexible liner assembly; and
connecting portions of the flexible liner assembly to the pipe section so that the flexible liner assembly provides a substantially leak-free conduit through the pipe section.

12. The method of claim 11, wherein the steps of pushing and pulling the flexible liner assembly are performed simultaneously.

13. The method of claim 11, wherein the steps of pushing and pulling the flexible liner assembly are performed in sequence.

14. The method of claim 11, wherein the flexible liner assembly comprises a flexible bore liner and a semi-rigid helix.

15. The method of claim 11, wherein the step of pulling the flexible liner assembly includes the steps of connecting a trailing end of a tag line to the flexible liner assembly and pulling the tag line.

16. The method of claim 15, further comprising the steps of measuring a length of the pipe section using the tag line and using the measured length to determine a design length for the flexible liner assembly.

17. The method of claim 11, further comprising the steps of attaching end plugs to the first and second ends of the flexible liner assembly to maintain the internal pressure, and removing the end plugs to release the internal pressure.

18. A method for repairing or reinforcing a pipe section, comprising the steps of:
determining a length of the pipe section;
providing a flexible liner assembly having a first end, a second end, and a length within about 10% of the length of the pipe section;
applying an internal pressure to the flexible liner assembly;
maintaining the internal pressure using end plugs attached to the first and second ends of the flexible liner assembly;
pushing the flexible liner assembly at least part of a distance through the pipe section while maintaining the internal pressure;
releasing the internal pressure from the flexible liner assembly by removing the end plugs; and
connecting the first and second ends of the flexible liner assembly to the pipe section so that the flexible liner assembly provides a substantially leak-free conduit through the pipe section.

19. The method of claim 18, further comprising the step of pulling the flexible liner assembly at least part of the distance through the pipe section using a tag line.

20. The method of claim 18, wherein the step of connecting the first and second ends of the flexible liner assembly to the pipe section includes the steps of connecting a first retainer sleeve to a first end of the flexible liner assembly and a corresponding second end of the pipe section and connecting a second retainer sleeve to a second end of the flexible liner assembly and a corresponding first end of the pipe section.
